(19) United States
(12) Patent Application Publication
(10) Pub. No.: US 2010/0123703 A1
(43) Pub. Date: May 20, 2010

(54) Driving circuit for liquid crystal display and method thereof

(75) Inventors: Wei Guo, Shenzhen (CN); Sha Feng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: Innocom Technology (Shenzhen) Co., Ltd.; Innolux Display Corp.

(21) Appl. No.: 12/590,756

(22) Filed: Nov. 13, 2009

(30) Foreign Application Priority Data
Nov. 14, 2008 (CN) 200810217819.8

(51) Int. Cl. G09G 5/00

(52) U.S. Cl. 345/211

(57) ABSTRACT

A driving circuit for a liquid crystal display includes a gate driver configured for generating scanning signals, a power circuit configured for providing an operating voltage to the gate driver, a timing controller configured for providing a clock signal having a variable frequency, and a voltage adjusting circuit located between the power circuit and the gate driver, for adjusting the operating voltage applied to the gate driver under control of the timing controller. Waveforms of the scanning signals include cutting angles corresponding to the variable frequency of the clock signal.

### BACKGROUND

1. Technical Field

The present disclosure relates to a driving circuit for a liquid crystal display (LCD) and a method thereof.

2. Description of Related Art

LCDs are widely used in various devices, such as notebooks, personal digital assistants (PDAs) and video cameras.

A frequently used LCD includes a plurality of pixels arranged in a matrix, and a driving circuit for driving the pixels. Generally, the driving circuit includes a gate driver configured to provide a plurality of scanning signals to activate the pixels row by row. Each of the scanning signals is typically a periodical square wave signal having a high voltage (namely a logical “1”) and a low voltage (namely a logical “0”) alternating with each other. The high voltage activates a corresponding row of pixels, and enables them to receive data signals from a data driver.

However, parasitic components exist in the pixels, for example, a parasitic capacitor may be introduced to a thin film transistor between a gate electrode and a source electrode thereof in the pixel during the manufacturing process of the LCD. Accordingly, the square-wave scanning signals may be distorted when applied to the pixels, possibly generating flicker, degrading display quality of the LCD.

What is needed, therefore, is a driving circuit and a method for driving an LCD that can overcome the described limitations.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a diagram of a driving circuit for an LCD according to a first embodiment of the present disclosure.

FIG. 2 is a waveform diagram showing waveforms in the driving circuit of FIG. 1 when the LCD adopts a high refresh frequency and a low refresh frequency respectively.

FIG. 3 is a diagram of a driving circuit for an LCD according to a second embodiment of the present disclosure.

### DETAILED DESCRIPTION

Reference will now be made to the drawings to describe certain exemplary embodiments of the present disclosure in detail.

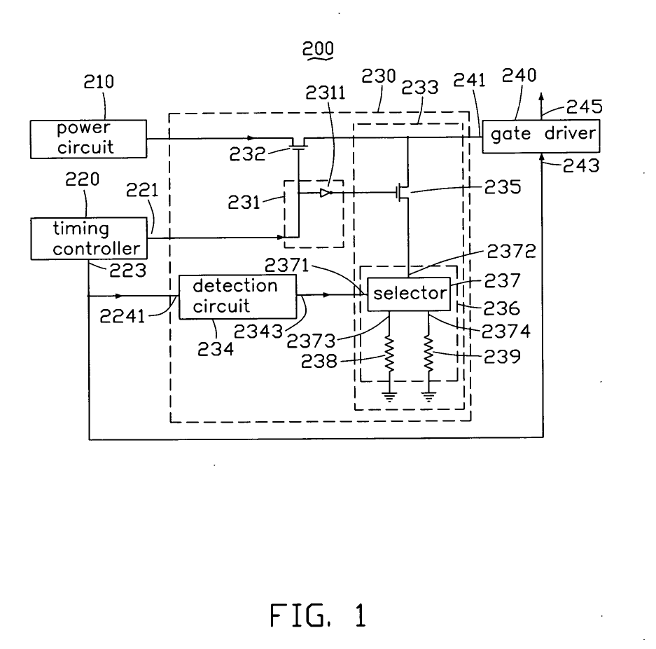

FIG. 1 illustrates a driving circuit 200 according to a first embodiment of the present disclosure. The driving circuit 200 can be adopted in a display device, such as an LCD, for example. In particular, the LCD may include a liquid crystal panel having a plurality of pixels arranged in a matrix, and the driving circuit 200 can be used to drive the matrix of pixels.

Referring to FIG. 1, the driving circuit 200 includes a power circuit 210, a timing controller 220, a voltage adjusting circuit 230, and a gate driver 240.

The power circuit 210 is adapted to provide an operating voltage. The operating voltage is typically a direct current (DC) operating voltage, which can be generated by the power circuit 210 by rectifying and filtering an alternating current (AC) voltage signal.

The timing controller 220 is adapted to provide a control signal to the voltage adjusting circuit 230 via a first output terminal 221, and provide a clock signal to the gate driver 240 via a second output terminal 223. The clock signal directs the gate driver 240 to generate a plurality of scanning signals. The control signal directs the voltage adjusting circuit 230 to transmit the operating voltage output from the power circuit 210 to the gate driver 240 or discharge the operating voltage applied to the gate driver 240, to adjust waveforms of the scanning signals generated by the gate driver 240.

The gate driver 240 is adapted to generate and output the scanning signals to the matrix of pixels to activate the pixels row by row. In particular, the gate driver 240 may include a first input terminal 241 electrically coupled to an output of the voltage adjusting circuit 230, a second input terminal 243 electrically coupled to the timing controller 220 for receiving the clock signal from the timing controller 220, and a scanning signal output 245 for outputting the scanning signals.

The voltage adjusting circuit 230 is adapted to adjust the scanning signals generated by the gate driver 240 by controlling the transmission of the operating voltage from the power circuit 210 to the gate driver 240 and discharging the operating voltage applied to the gate driver 240, to form a cutting angle in the waveform of the scanning signal. The voltage adjusting circuit 230 may include a switch control circuit 231, a first switch 232, a discharge circuit 233, and a detection circuit 234. The switch control circuit 231 directs working states of both the first switch 232 and the discharge circuit 233 according to the control signal provided by the timing controller 220. For example, based on the control signal, the switch control circuit 231 may disable the discharge circuit 233 when the first switch 232 is switched on, and enable the discharge circuit 233 to function when the first switch 232 is switched off.

The first switch 232 can be a controllable electronic switch (e.g., a transistor) having a control terminal. The controllable electronic switch may be electrically coupled between an output terminal (not labeled) of the power circuit 210 and the input terminal 241 of the gate driver 240, and the control terminal (a gate electrode) of the controllable electronic switch is electrically coupled to the switch control circuit 232. The switch control circuit 232 may include an inverter 2311, to reverse the control signal output by the timing controller 220. An input terminal of the inverter 2311 is electrically coupled to the first output terminal 221 of the timing controller 220, and is further electrically coupled to control terminal of the first switch 232. An output terminal of the inverter 2311 is electrically coupled to the discharge circuit 233, and directs the working state of the discharge circuit 233.

The discharge circuit 233 may include a second switch 235 and a variable resistor module 236. The second switch 235 may also be a controllable electronic switch (such as a transistor) electrically coupled between the first input terminal 241 of the gate driver 240 and the variable resistor module 236, with a control terminal thereof electrically coupled to the output terminal of the inverter 2311. The variable resistor module 236 may include a selector 237, a first resistor 238, and a second resistor 239. The selector 237 may be a two-to-one selector, which includes a control end 2371, a selective end 2372, a first fixed end 2373, and a second fixed end 2374. The control end 2371 is electrically coupled to the detection circuit 234, and is configured to receive a selection control signal from the detection circuit 234. The selection control signal may be used to control the selective end 2372 to electrically couple to a selected one of the fixed ends 2373, 2374. The selective end 2372 is electrically coupled to the second switch 235. The first fixed end 2373 and the second fixed end 2374 are respectively grounded via the first resistor 238 and the second resistor 239.

The detection circuit 234 is adapted to detect a frequency of the clock signal output by the timing controller, and output a corresponding selection control signal. The detection circuit 234 may include a detecting terminal 2241 electrically coupled to the second output terminal 223 of the timing controller 220, and a selection control signal output terminal 2343 electrically coupled to the control end 2371 of the selector 237.

In operation, the timing controller 220 outputs the clock signal to the gate driver 240, to direct the gate driver 240 to generate a plurality of periodical scanning signals. The periodical scanning signals are used for activating the pixels row by row. A frequency of the scanning signal corresponds to a refresh frequency of the LCD, and a minimum period of the scanning signal can be divided into a high voltage sub-period and a low voltage sub-period.

The detection circuit 234 detects a frequency of the clock signal by sampling the clock signal at the second output terminal 223 of the timing controller 220, and then generating and outputting the selection control signal to the selector 237 based on the detected frequency. The selector 237 selects one of the resistors 238, 239 according to the selection control signal, and electrically couples the selected resistor to the second switch 235.

Moreover, the timing controller 220 also provides a control signal to the voltage adjusting circuit 230. The control signal can be a periodical pulse signal having a first voltage value and a second alternating voltage value. In addition, a period of the control signal is substantially the same as that of the scanning signal, with a duty ratio of the control signal being less than that of the scanning signal.

The control signal is directly applied to the first switch 232, and also applied to the second switch 235 via the inverter 2311. The inverter 2311 inverts the control signal, and contrasts a voltage value of the control signal applied to the second switch 235 with that applied to the first switch 232. In detail, when the control signal output from the timing controller 220 is of the first voltage value, the first switch 232 is turned on and the second switch 235 is turned off, thus, the discharge circuit 233 is disabled and an operating voltage output from the power circuit 210 transmitted to the gate driver 240. When the control signal is of the second voltage value, the first switch 232 is turned off and the second switch 235 is turned on, thus, the discharge circuit 233 is able to function and the received operating voltage of the gate driver 240 is discharged via the discharge circuit 233.

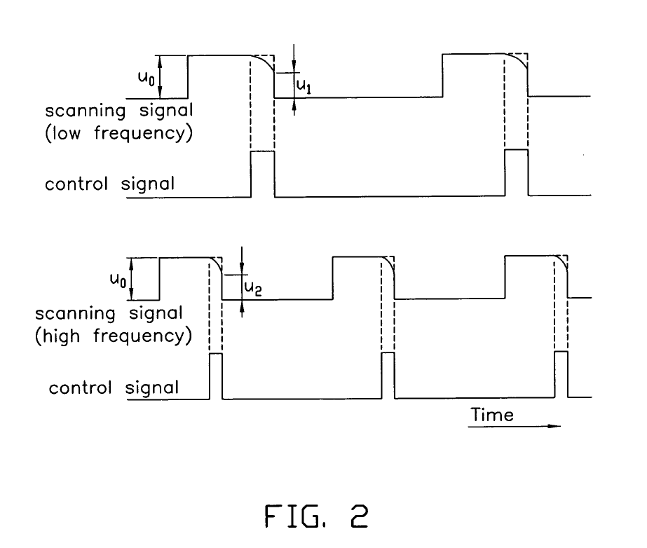

Due to the discharging process, a cutting angle is formed in a waveform of the scanning signal output by the gate driver 240, as shown in FIG. 2. In detail, when the control signal is of the first voltage value, the transmission of the operating voltage is performed and a voltage of the scanning signal is substantially the same as the operating voltage u0 in a high voltage sub-period. At the end of the high voltage sub-period, the control signal turns to the second voltage value, and the discharging process starts. This gradually lowers the voltage of the scanning signal until the low voltage sub-period begins (the voltage of scanning signal turns to u1 or u2 in this instance), thereby forming a cutting angle in the waveform of the scanning signal.

As can be seen, in the illustrated embodiment of the present disclosure, the voltage adjusting circuit 230 adjusts the waveform of the scanning signal to include the cutting angle. Such cutting angle may compensate distortion of the scanning signal due to parasitic components in the pixels, such that flicker can be reduced or even eliminated. Display quality of the LCD is thus improved.

It is noted that a refresh frequency of the LCD may influence a grade of the above-described distortion of the scanning signal, with the grade of the distortion increasing with refresh frequency. Because the cutting angle is generated by the discharge circuit 233, a shape of the cutting angle can be modulated by adjusting a discharge rate of the discharge circuit 233, to meet the compensation requirement corresponding to different refresh frequencies. In addition, as the discharge rate is determined by a resistance of the discharge path of the discharge circuit 233, the shape of the cutting angle can be modulated by selecting an appropriate resistor.

Referring to FIG. 2, when a refresh frequency of the LCD changes, a period of the scanning signal changes correspondingly. In this situation, a frequency of the clock signal is adjusted by the timing controller 220, to enable the gate driver 240 to provide appropriate scanning signals. Upon detecting that the frequency of the clock signal changes, the detection circuit 234 provides a new selection control signal to the selector 237. The new selection control signal directs the selector 237 to re-select an appropriate resistor in the variable resistor module 236, to adjust the discharge rate of the discharge circuit 233 and further modulate the shape of the cutting angle to adapt the changing of the refresh frequency.

For example, when the refresh frequency is turned down, the detection circuit 234 may output a first selection control signal to direct the selector 237 to select a resistor with a relatively greater resistance, such that a discharge rate of the discharge circuit 233 is reduced. In contrast, when the refresh frequency is increased, the detection circuit 234 may output a second selection control signal to direct the selector 237 to select a resistor with relatively less resistance, such that a discharge rate of the discharge circuit 233 is increased. As such, the shape of the cutting angle in the waveform of the scanning signal is modulated.

From the description, it can be found that the shape of the cutting angle in the waveform of the scanning signal is determined by the frequency of the clock signal in the embodiment of the present disclosure. In summary, with the illustrated configuration, a discharge rate of the discharge circuit 233 in the voltage adjusting circuit 233 can be controlled according to the refresh rate of the LCD. Thus, the shape of the cutting angle in the waveform of the scanning signal can be modulated to adapt to the change of the refresh frequency, to compensate different grades of signal distortion.

In addition, when a proportion of resistance between the resistors 238 and 239 is similar to or even the same as that between the relative high refresh frequency and the relatively low refresh frequency, it is possible to substantially normalize the voltage u1 of the scanning signal with a high frequency with the voltage u2 of the scanning signal with a low frequency upon entering the low-voltage sub-period. This can further improve the display quality of the LCD.

Furthermore, based on the operation of the driving circuit 200 described, a method for driving an LCD as disclosed can be summarized as follows. The method may include a timing controller providing a clock signal to a gate driver to direct the gate driver to generate a scanning signal, a detection circuit detecting, a frequency of the clock signal, and a voltage adjust circuit adjusting the scanning signal to form a cutting angle in a waveform thereof according to the frequency of the clock signal.

In particular, the cutting angle can be formed by discharging an operating voltage applied to the gate driver periodically, and a rate of the discharging process can be controlled by a selection control signal generated by the detection circuit according to the frequency of the clock signal.

Moreover, the discharging process for the operating voltage may further include selecting a resistor from a plurality of resistors of different value to form a discharge path according to the selection control signal and a switch control circuit enabling the discharge path through turning on a switch in the discharge path periodically according to a control signal output by the timing controller; and transmitting the operating voltage output from an operating voltage to the gate driver when the switch in the discharge path is turned off.

A resistor may be selected for having less resistance when the selection control signal corresponds to a high frequency of the clock signal and having higher resistance when the selection control signal corresponds to a low frequency of the clock signal.

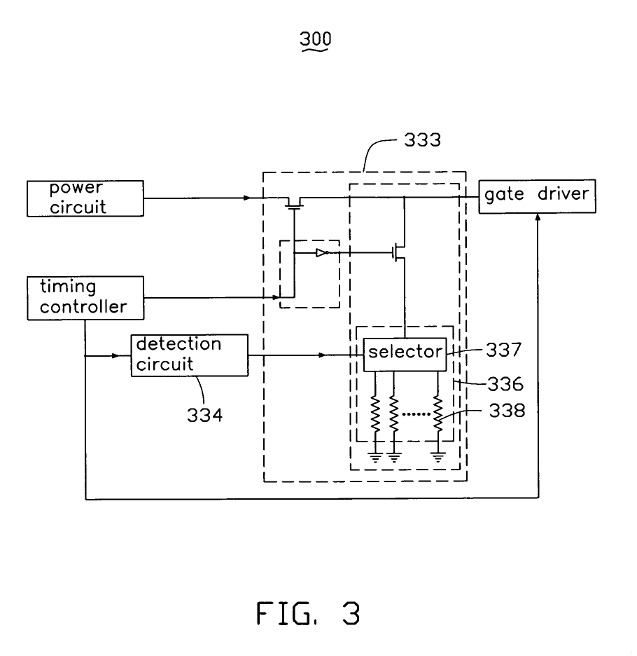

FIG. 3 illustrates a driving circuit 300 according to another exemplary embodiment of the present disclosure, differing from driving circuit 200 in that a discharge circuit 333 of the voltage adjusting circuit 330 includes a variable resistor module 336 having a plurality of resistors 338 electrically coupled to a selector 337. In operation, the selector 337 can select a corresponding resistor 338 to control a discharge rate of the discharge circuit 333 according to a selection control signal provided by a detection circuit 334. The utilization of the plurality of resistors 338 enables the driving circuit 300 to meet the multiple refresh frequencies of the LCD.

It is to be understood, however, that even though numerous characteristics and advantages of the present embodiments have been set out in the foregoing description, together with details of the structures and functions of the embodiments, the disclosure is illustrative only; and that changes may be made in detail, especially in matters of arrangement of parts within the principles of the disclosure to the full extent indicated by the broad general meaning of the terms in which the appended claims are expressed.

What is claimed is:

1. A driving circuit for a liquid crystal display, comprising:
a gate driver configured for generating scanning signals;
a power circuit configured for providing an operating voltage to the gate driver;
a timing controller configured for providing a clock signal having a variable frequency; and
a voltage adjusting circuit located between the power circuit and the gate driver, for adjusting the operating voltage applied to the gate driver under control of the timing controller;
wherein waveforms of the scanning signals comprise cutting angles corresponding to the variable frequency of the clock signal.

2. The driving circuit of claim 1, wherein the voltage adjusting circuit comprises a discharge circuit coupled to the gate driver, configured to periodically discharge the operating voltage applied to the gate driver according to a control signal provided by the timing controller.

3. The driving circuit of claim 2, wherein the voltage adjusting circuit comprises a detection circuit configured for detecting the frequency of the clock signal.

4. The driving circuit of claim 3, wherein the detection circuit is further configured to provide a corresponding selection control signal to the discharge circuit according to the frequency of the clock signal, to control a discharge rate of the discharge circuit.

5. The driving circuit of claim 4, wherein the discharge circuit comprises a variable resistor module electrically coupled between the gate driver and the detection circuit, wherein the variable resistor is configured to provide a resistor having a resistance value corresponding to the selection control signal, and the discharge rate is controlled according to resistance value.

6. The driving circuit of claim 5, wherein the variable resistor module comprises a selector and at least two resistors of different resistance values, the selector configured to select a corresponding resistor to form a discharge path according to the selection control signal.

7. The driving circuit of claim 6, wherein the selector selects a resistor having lower resistance when the selection control signal corresponds to a high frequency of the clock signal, and selects a resistor having higher resistance when the selection control signal corresponds to a low frequency of the clock signal.

8. The driving circuit of claim 6, wherein the voltage adjusting circuit further comprises a first switch and a switch control circuit, the operating voltage is applied to the gate driver via the first switch, and the switch control circuit is configured to disable the discharge circuit when the first switch is turned on and enable the discharge circuit when the first switch is turned off based on the control signal.

9. The driving circuit of claim 8, wherein the discharge circuit further comprises a second switch in the discharge path, the first switch and the second switch are turned on alternately as directed by the switch control circuit.

10. The driving circuit of claim 9, wherein the switch control circuit comprises a inverter, an input terminal of which is coupled to a control terminal of the first switch, and is configured to receive the control signal, and an output terminal of which is coupled to a control terminal of the second switch.

11. A method for driving a liquid crystal display, comprising:
providing a clock signal to a gate driver to direct the gate driver to generate a scanning signal;
detecting a frequency of the clock signal; and
adjusting the scanning signal to form a cutting angle in a waveform of the scanning signal according to the frequency of the clock signal.

12. The method of claim 11, wherein the cutting angle is formed by periodically discharging an operating voltage applied to the gate driver.

13. The method of claim 12, wherein a rate of the discharging process is controlled by a selection control signal generated by the detection circuit according to the frequency of the clock signal.

14. The method of claim 13, wherein periodic discharge of an operating voltage applied to the gate driver comprises:
selecting a resistor from a plurality of resistors of different resistance values to form a discharge path according to the selection control signal; and
enabling, by a switch control circuit, the discharge path by turning on a switch in the discharge path periodically according to a control signal output by a timing controller providing the clock signal.

15. The method of claim 14, wherein the process of selecting a resistor comprises:
selecting a resistor having a less resistance when the selection control signal corresponds to a high frequency of the clock signal; and
selecting a resistor having higher resistance when the selection control signal corresponds to a low frequency of the clock signal.

16. The method of claim 14, wherein periodic discharge of an operating voltage applied to the gate driver further comprises the voltage adjusting circuit transmitting the operating voltage output from an operating voltage to the gate driver when the a switch in the discharge path is turned off.

17. The method of claim 16, wherein the transmission of the operating voltage to the gate driver is controlled by the switch control circuit according to the control signal.

18. The method of claim 17, wherein the switch control circuit comprises a inverter directing the transmission of the operating voltage and the discharging process to be performed alternatingly based on the control signal.
